(19) United States
(12) Patent Application Publication
(10) Pub. No.: US 2020/0398307 A1
(43) Pub. Date: Dec. 24, 2020

(54) SUPERHYDROPHOBIC SURFACES

(71) Applicant: Massachusetts Institute of Technology, Cambridge, MA (US)

(72) Inventors: Koroush Shirvan, Boston, MA (US); Arunkumar Seshadri, Cambridge, MA (US); Bren Phillips, Upton, MA (US)

(73) Assignee: Massachusetts Institute of Technology, Cambridge, MA (US)

(21) Appl. No.: 16/842,110

(22) Filed: Apr. 7, 2020

Related U.S. Application Data
(60) Provisional application No. 62/862,882, filed on Jun. 18, 2019.

(51) Int. Cl. B05D 3/06; B05D 1/00

(52) U.S. Cl. CPC B05D 3/068; B05D 1/60; B05D 2202/15; B82Y 30/00; B05D 2518/10; B05D 2202/30; B05D 2202/45; B05D 2203/30

(57) ABSTRACT

Articles and methods related to superhydrophobic surfaces are generally described. In some embodiments, an article may include a substrate and a plurality of nanoscale and/or microscale features may be formed on a surface of the substrate by irradiating the substrate. The plurality of nanoscale and/or microscale features may comprise oxides and/or hydroxides on the surface of the substrate. A fluorinated coating may be associated with at least a portion of the surface of the substrate, including, for example, the nanoscale and/or microscale features may be coated with the fluorinated coating.

### RELATED APPLICATIONS

This application claims the benefit of priority under 35 U.S.C. § 119(e) of U.S. Provisional Application No. 62/862,882, filed Jun. 18, 2019, the disclosure of which is incorporated by reference in its entirety.

### TECHNICAL FIELD

Articles and methods related to superhydrophobic surfaces are generally described.

### BACKGROUND

Superhydrophobic metallic surfaces are of practical importance in various industries due to their corrosion resistance, self-cleaning abilities, and heat transfer abilities. Various procedures to create hydrophobic surfaces have included depositing nanostructured coatings onto a substrate, exposing a substrate to plasma followed by fluorination, and etching a substrate followed by fluorination.

### SUMMARY

Articles and methods related to superhydrophobic surfaces are generally described.

Certain embodiments are related to an article, the article comprising a substrate, a plurality of nanoscale and/or microscale features on a surface of the substrate, wherein the plurality of nanoscale and/or microscale features comprise oxides and/or hydroxides on the surface of the substrate, and a fluorinated coating associated with at least a portion of the surface of the substrate.

In some embodiments, a method of producing a superhydrophobic material is described, the method comprising irradiating a surface of a substrate with gamma irradiation, exposing the irradiated substrate to a fluorinated species, and coating at least a portion of the surface of the irradiated substrate with the fluorinated species.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is, according to some embodiments, a flow chart describing a method of producing a superhydrophobic material;

FIG. 2A is, according to some embodiments, an image of a surface exposed to gamma irradiation with scale bar equal to 2 micrometers;

FIG. 2B is, according to some embodiments, an image of a surface exposed to gamma irradiation with scale bar equal to 10 micrometers;

FIG. 3 shows, according to some embodiments, images of the contact angle measurement for stainless steel for various conditions;

FIG. 4 is a table of contact angle measurements for different sample compositions exposed to different surface treatment conditions.

### DETAILED DESCRIPTION

The Inventors have realized and appreciated that gamma irradiation of a substrate (e.g., metallic substrate) in combination with a fluorinated chemical treatment provides materials having a superhydrophobic surface. In some embodiments, the material is formed by first irradiating a substrate (e.g., metallic substrate) with an appropriate dose of gamma irradiation (e.g., 300 kiloGray) in order to provide localized oxidation of a surface of the substrate (e.g., metallic substrate). In some aspects, for example, subjecting the surface of a substrate (e.g., metallic substrate) to gamma irradiation may result in a plurality of nanoscale and/or microscale features that comprise oxides and/or hydroxides formed on the surface of the substrate as a result of oxidation of the surface (e.g., metallic surface). Following irradiation of the substrate, the substrate surface may be further subjected to chemical fluorination in order to coat at least a portion of the nanoscale and/or microscale features with a fluorinated coating. For instance, the fluorinated coating may be deposited onto the nanoscale and/or microscale features. At least a portion of the fluorinated coating may be chemically bound to the oxides and/or hydroxides of the nanoscale and/or microscale features disposed on the surface of the substrate. The resulting gamma irradiated, fluorine-coated surfaces may exhibit superhydrophobic properties, as described below. In some applications, the superhydrophobic properties of an article may be engineered to control the heat transfer characteristics of the article.

An article including a superhydrophobic surface as described herein may comprise any of a variety of suitable substrates. Further, the substrate may comprise any of a variety of suitable materials. According to certain embodiments, the substrate may comprise a material having an average crystal size above a threshold value, such that when the substrate material is oxidized (e.g., with irradiation, as is explained herein in greater detail), the resulting hydroxides and/or oxides are created on the surface of the substrate in a dispersive manner. For example, in some embodiments, the substrate may comprise a material having an average crystal size greater than or equal to 100 nm, greater than or equal to 500 nm, greater than or equal to 1 micrometer, greater than or equal to 5 micrometers, greater than or equal to 10 micrometers, greater than or equal to 50 micrometers, or greater than or equal to 100 micrometers. In some embodiments, the substrate comprise a material having an average crystal size less than or equal to 500 micrometers, less than or equal to 100 micrometers, less than or equal to 50 micrometers, less than or equal to 10 micrometers, less than or equal to 5 micrometers, less than or equal to 1 micrometers, or less than or equal to 500 nm. Combinations of the above recited ranges are also possible (e.g., the substrate comprises a material having an average crystal size greater than or equal to 100 nm and less than or equal to 500 micrometers, the substrate comprises a material having an average crystal size and/or grain boundary of greater than or equal to 500 nm and less than or equal to 10 micrometers). While specific combinations are noted, other combinations are also possible and ranges both greater and less than those noted above are contemplated as the disclosure is not so limited.

In the above embodiments, the average crystal size may be measured using any appropriate technique as is known in the art including, but not limited to, x-ray diffraction analysis, transmission electron microscopy (TEM), metallographic etching and microscopy, and/or any other appropriate measurement technique.

In certain embodiments, the substrate comprises a metal and/or a metal alloy. For example, the substrate may be comprised of stainless steel (e.g., grade 316 stainless steel), zirconium alloy (e.g., Zircaloy-4), copper (e.g., grade 110 copper), chromium, and/or any other appropriate material. According to some embodiments, the substrate (e.g., metal substrate or other appropriate underlying material) may be coated (e.g., with another metal, metal alloy, or other appropriate material). For example, in certain non-limiting embodiments, the substrate comprises a chromium metal coating or a FeCrAl alloy coating. Alternatively, in some embodiments, the substrate may comprise a ceramic. For example, the substrate may comprise silicon carbide. Further, in some embodiments, a surface of the substrate may be at least partially oxidized prior to subjecting the surface to irradiation (e.g., due to, for example, water and/or oxygen in the ambient atmosphere).

A substrate used to form the articles described herein may be of any of a variety of suitable shapes or sizes. For example, the substrate may at least partially be in the form of a sheet, layer, block, tube, rod, and the like.

As noted above, in some embodiments, an article may comprise a plurality of nanoscale and/or microscale features on a surface of the substrate. In some embodiments, the presence of a plurality of nanoscale and/or microscale features on the surface of the substrate may advantageously increase the hydrophobicity of the substrate surface. Without wishing to be bound by theory, for example, it may be more energy intensive for a liquid (e.g., water) to wet the substrate comprising the plurality of nanoscale and/or microscale features, as compared to a substrate without the plurality of nanoscale and/or microscale features that is otherwise equivalent.

In some embodiments, the nanoscale and/or microscale features may correspond to islands of oxides and/or hydroxides formed on a surface of a substrate. However, embodiments in which the islands are interconnected, and/or the microscale and/or nanoscale features form other structures on a substrate surface, are also possible.

As noted above, according to certain embodiments, an article may include a fluorinated coating associated with at least a portion of a surface of the substrate. The fluorinated coating may comprise any of a variety of suitable fluorinated species. In some aspects, for example, the fluorinated coating comprises a fluorinated silane. Examples of fluorinated silanes include: fluorosilane; alkyl fluorosilanes such as 1H,1H,2H,2H-perfluorodecyltriethoxysilane; a fluorinated compound in combination with an alkyl silane (e.g. NH₄F and an alkyl silane); combinations of the forgoing, and/or any other appropriate fluorinated species.

In some embodiments, the fluorinated coating is attached to at least a portion of the surface of the substrate by chemical bonding. In one such embodiment, the fluorinated coating may be attached to and disposed on the microscale and/or nanoscale features disposed on a surface of the substrate. For example, one or more fluorinated species of the fluorinated coating (e.g., a fluorinated silane) may be attached to at least a portion of the surface of the substrate (e.g., an oxide and/or a hydroxide) by a chemical bond. In some embodiments, one or more chemical species of the fluorinated coating is chemically bound to the surface of the substrate by covalent bonding. In certain aspects, one or more chemical species of the fluorinated coating is chemically bound to the surface of the substrate by non-covalent bonding, which includes electrostatic interactions (e.g., ionic interactions, hydrogen bonding, van der Waals forces, and/or hydrophobic interactions). Without wishing to be bound by theory, in some embodiments, the type of chemical bond that the fluorinated coating makes with the surface of the substrate may depend on the chemical composition of the substrate and the fluorinated coating.

In some embodiments, the surface comprises a plurality of nanoscale features. “Nanoscale” is used herein in a manner consistent with its ordinary meaning in the art. Nanoscale features, for example, are features having a maximum dimension from 1 nm to less than 1 micrometer. According to some embodiments, for example, the maximum dimension of the nanoscale features may be from 1 nm to 100 nm, 100 nm to 200 nm, 200 nm to 300 nm, 300 nm to 500 nm, 500 nm to 700 nm, or 700 nm to less than 1 micrometer. Combinations of the above cited ranges are also possible (e.g., the maximum dimension of the nanoscale features may be from 300 nm to 700 nm, or the maximum dimension of the nanoscale features may be from 200 nm to 1 micrometer). Other combinations are also possible.

According to certain embodiments, the surface comprises a plurality of microscale features. “Microscale” is used herein in a manner consistent with its ordinary meaning in the art. Microscale features, for example, are features having a maximum dimension from 1 micrometer to 100 micrometers. According to some embodiments, the maximum dimension of the microscale features may be from 1 micrometer to 10 micrometers, 10 micrometers to 20 micrometers, 20 micrometers to 30 micrometers, 30 micrometers to 50 micrometers, 50 micrometers to 70 micrometers, or 70 micrometers to 100 micrometers. Combinations of the above cited ranges are also possible (e.g., the maximum dimension of the microscale features may be from 30 micrometers to 70 micrometers, or the maximum dimension of the microscale features may be from 20 micrometers to 100 micrometers). Other combinations are also possible.

According to certain embodiments, the maximum dimension of the nanoscale and/or microscale features may be measured by electron microscopy techniques, such as scanning electron microscopy (SEM) and/or transmission electron microscopy (TEM). The electron microscopy techniques can be supplemented by, for example, profilometry (e.g., optical or contact).

In some aspects, the nanoscale and/or microscale features may be relatively regularly spaced across at least a portion of the external surface. According to certain embodiments, the nanoscale and/or microscale features may have any of a variety of suitable feature characteristic spacings. As used herein, the characteristic spacing of a particular feature refers to the shortest distance between the surface of the feature and the surface of that feature's nearest neighbor. In certain embodiments, for example, the average characteristic spacing between the nanoscale and/or microscale features, when present, is at least 1 nm, at least 50 nm, at least 100 nm, at least 200 nm, at least 300 nm, at least 500 nm, at least 700 nm, at least 1 micrometer, at least 5 micrometers, at least 10 micrometers, at least 30 micrometers, at least 50 micrometers, at least 90 micrometers, and the like. Correspondingly, the average characteristic spacing may be less than or equal to 90 micrometers, 50, micrometers, 30 micrometers, 20 micrometers, 10 micrometers, 1 micrometer, and/or any other appropriate range. Combinations of the above ranges of the average characteristic spacing between the nanoscale and/or microscale features are contemplated including, for example, an average characteristic spacing between the nanoscale and/or microscale features that is between or equal to 1 nm and 90 micrometers.

According to some embodiments, the plurality of nanoscale and/or microscale features comprise oxides and/or hydroxides disposed on the surface of the substrate. The oxides and/or hydroxides may be formed as a result of an oxidizing reaction at the surface of the substrate upon irradiation (e.g., gamma irradiation). In some aspects, the oxides and/or hydroxides that are formed may be an oxide and/or hydroxide of the substrate (e.g., a metallic and/or ceramic substrate). In certain non-limiting embodiments, for example, the substrate may be bare copper prior to radiation (e.g., gamma radiation) exposure, and the substrate surface may include microscale and/or nanoscale features corresponding to copper-oxides and/or copper hydroxides disposed on a surface of the substrate after radiation exposure. In certain embodiments, the presence and/or amount of oxides and/or hydroxides on the surface of the substrate may be determined, for example, using energy-dispersive X-ray spectroscopy (EDS) and/or X-ray photoelectron spectroscopy (XPS).

According to certain embodiments, at least a portion of the substrate surface may be omniphobic (e.g., non-wetting with respect to a liquid). In some embodiments, at least a portion of the substrate surface may be superhydrophobic with respect to a liquid (e.g., water). As used herein, a surface is considered to be superhydrophobic with respect to a liquid (e.g., water) when, if a droplet of the liquid is positioned on the surface in a gaseous environment at the temperature and pressure at which the liquid and the surface are being used, the droplet forms a contact angle, as measured through the bulk of the droplet, of greater than or equal to 150° and less than or equal to the maximum physically possible contact angle of 180°. For example, at least a portion of the surface may have a water contact angle of greater than or equal to 90°, greater than or equal to 100°, greater than or equal to 110°, greater than or equal to 120°, greater than or equal to 130°, greater than or equal to 140°, greater than or equal to 150, and/or any other appropriate contact angle.

Without wishing to be bound by theory, it should be understood by a person of ordinary skill in the art that any reference to the superhydrophobicity of the substrate surface described herein may also refer to the superomniphobicity of the substrate surface, such that the surface of the substrate is superomniphobic to a range of species (e.g., liquids such as oil, blood, organics, etc.) in addition to water.

Correspondingly, in some embodiments, at least a portion of the surface has a water contact angle of less than or equal to 180°, less than or equal to 170°, less than or equal to 160°, less than or equal to 150°, less than or equal to 140°, less than or equal to 130°, less than or equal to 120°, less than or equal to 110°, or less than or equal to 100°, and/or any other appropriate contact angle. Combinations of the above recited ranges are also possible (e.g., at least a portion of the surface has a water contact angle of greater than or equal to 90° and less than 180°, or at least a portion of the surface has a water contact angle of greater than or equal to 120° and less than or equal to 130°). Other combinations are also possible.

Turning now to the figures, several non-limiting embodiments are described in further detail. However, it should be understood that the current disclosure is not limited to only the specific embodiments detailed in respect to the figures, and that the various aspects and features of the different embodiments may be combined with one another in any appropriate fashion as the disclosure is not limited in this fashion.

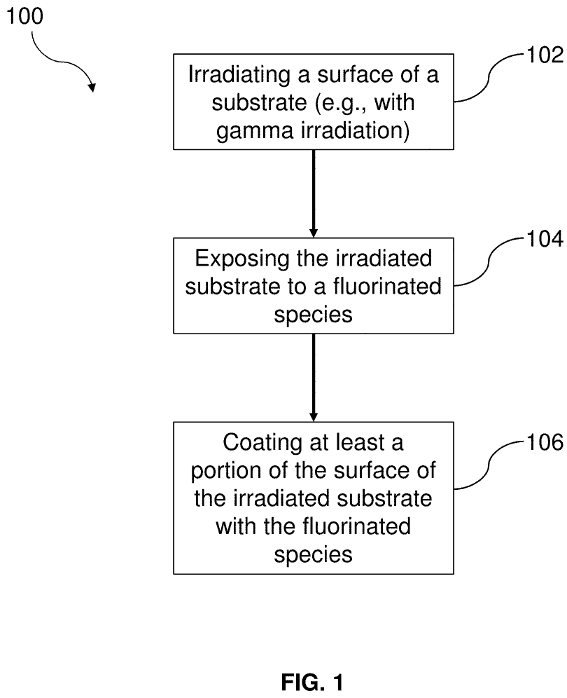

FIG. 1 depicts one embodiment of a method for producing a superhydrophobic material. Specifically, the figure depicts a flow chart describing processes for producing a superhydrophobic material. According to some embodiments, the method comprises irradiating a surface of a substrate with gamma irradiation at step 102. Without wishing to be bound by theory, irradiating the surface of the substrate with gamma irradiation allows for localized oxidation of the substrate and the formation of a plurality of nanoscale and/or microscale features comprising oxides and/or hydroxides on a surface of the substrate exposed to the irradiation.

According to some embodiments, the method further comprises exposing the irradiated surface of the substrate to oxygen, hydrogen and/or hydroxides during irradiation. This may include positioning the substrate within an environment at least partially including oxygen, hydrogen, and/or hydroxides. For example, an atmosphere within an irradiation chamber may be evacuated and replaced with a desired composition of gases including oxygen, hydrogen, and/or hydroxides in a desired partial pressure prior to irradiation. Alternatively, embodiments in which the atmosphere the substrate is exposed to during irradiation is an ambient atmosphere are also contemplated. Without wishing to be bound by theory, the presence of oxygen, hydrogen, and/or hydroxides during the irradiation step may provide a sufficient source of oxygen, hydrogen, and/or hydroxides for the localized formation a plurality of nanoscale and/or microscale features comprising oxides and/or hydroxides. As noted above, depending on the particular embodiment, the source of the oxygen, hydrogen, and/or hydroxides may be from a controlled atmosphere or an ambient atmosphere (e.g., O₂ and/or water vapor in the atmosphere).

In some aspects, irradiating the surface of a substrate includes irradiating the surface of the substrate with an appropriate amount of gamma irradiation. For example, irradiating may include irradiating the surface of the substrate with at least 120 kiloGray (kGy), at least 200 kGy, at least 300 kGy, at least 500 kGy, at least 1,000 kGy, at least 5,000 kGy, at least 10,000 kGy, at least 15,000 kGy, at least 20,000 kGy, and/or any other appropriate dosage of gamma irradiation. In certain embodiments, irradiating includes irradiating the surface of the substrate with less than or equal to 25,00 kGy, less than or equal to 20,000 kGy, less than or equal to 15,000 kGy, less than or equal to 10,000 kGy, less than or equal to 5,000 kGy, less than or equal to 1,000 kGy, less than or equal to 500 kGy, less than or equal to 300 kGy, less than or equal to 200 kGy, and/or any other appropriate dosage of gamma irradiation. Combinations of the above recited ranges are also possible (e.g., irradiating includes irradiating the surface of the substrate with at least 120 kGy and less than 25,000 kGy of gamma irradiation, or at least 500 kGy and less than or equal to 5,000 kGy of gamma irradiation). In some embodiments, the surface of a substrate may be irradiated with gamma radiation from a Cobalt-60 source. Other sources of gamma irradiation include a Cesium-137 source, Iodine-131 source, Iridium-192 source, and/or Americium-241 source, though any appropriate source of gamma radiation may be used.

In certain embodiments, irradiating a surface of a substrate (e.g., with gamma irradiation) may increase the wettability (e.g., hydrophilicity) of the surface of the substrate. Mechanisms of the increase in wettability of such substrates by irradiation are described in Applied Surface Science, 1 Jun. 2020, 514, 145935, entitled “Why ionizing radiation enhances surface wettability”, which is incorporated by reference herein in its entirety. In some embodiments, the surface of the substrate does not become superhydrophobic until the surface is exposed to a fluorinated species, which is explained in further detail herein.

The surface of the substrate may be irradiated for any of a variety of suitable amounts of time. For example, a surface of the substrate may be irradiated for a time greater than or equal to 1 hour, greater than or equal to 24 hours, or greater than or equal to 48 hours. In certain aspects, the surface may be irradiated for less than or equal to 72 hours, less than or equal to 48 hours, less than our equal to 24 hours, or less than or equal to 1 hour. Combinations of the above recited ranges are also possible (e.g., irradiating the surface of the substrate for greater than or equal to 1 hour and less than or equal to 72 hours, or irradiating the surface of the substrate for greater than 24 hours and less than 48 hours). Other combinations are also possible. Of course, it should be understood that the surface of a substrate may be irradiated with a net accumulated dosage over any appropriate amount of time including time periods both greater than and less than those noted above, as the disclosures not limited to any particular time period for applying a given dosage.

In some aspects, prior to fluorinating the irradiated sample, the oxidized surface may be protected from an ambient atmosphere in order to avoid contamination of the plurality of nanoscale and/or microscale features comprising oxides and/or hydroxides formed on a surface of a substrate. In certain embodiments, for example, the irradiated sample may be stored in an inert atmosphere such as helium, argon, or other suitable atmosphere that does not react with the surface of the substrate and/or the nanoscale and/or microscale features. Alternatively, in some embodiments, a substrate may be wrapped in a protective material such as a metal foil to protect the surface from an ambient atmosphere. In yet another embodiment, the irradiated sample may be stable in an ambient atmosphere for some amount of time. In such an embodiment, the sample may be exposed to the ambient atmosphere for a time period less than the threshold time prior to fluorinating the surface. This may include time periods that are less than or equal to about 1 hour, 2 hours, 3 hours, 4 hours, 5 hours, and/or any other appropriate time depending on the particular materials being used.

According to certain embodiments, prior to irradiation and/or exposure to a fluorinated species, at least a portion of the substrate may be intentionally masked. Masking the substrate prior to irradiation may advantageously expose only one or more portions of the substrate to the gamma irradiation. Suitable masking techniques would be known to a person of ordinary skill in the art including, for example, using nitride masks. Briefly, in some aspects, a mask may be applied to cover at least a portion of the substrate in any desired pattern and/or size scale. If the mask is applied prior to irradiation, the mask may form the microscale and/or nanoscale features in a desired pattern on a surface of the substrate. Alternatively, as explained in further detail below, the mask may be applied after formation of the microscale and/or nanoscale features, in which case the mask may prevent the masked portions of the substrate from being exposed to subsequent formation steps (e.g., fluorination). In either case, any appropriate type of mask may be used to form a desired pattern of superhydrophobic regions on a substrate.

After irradiating the substrate, the method may further comprise exposing the irradiated substrate to a fluorinated species at step 104. This may result in the fluorinated species being deposited onto a surface of the substrate, and in some embodiments, onto the microscale and/or nanoscale features present on the surface of the substrate. Exposing the irradiated substrate to the fluorinated species may advantageously provide a substrate surface with increased hydrophobicity, as compared to a substrate surface that is otherwise equivalent but has not been exposed to a fluorinated species. In some aspects, exposing the irradiated substrate to a fluorinated species may include vaporizing the fluorinated species in the presence of the irradiated substrate, immersing the irradiated substrate into a solution of the fluorinated species, or other techniques of exposing the substrate to the fluorinated species. In certain embodiments, at least a portion of the irradiated substrate surface is intentionally masked during exposure of the irradiated substrate to the fluorinated species. In some such embodiments, polymers such as poly(dimethylsiloxane) may be used for the mask.

In certain embodiments, exposing the irradiated substrate to the fluorinated species includes vapor depositing the fluorinated species onto the irradiated substrate. This may include chemical vapor deposition, as would be understood by those of ordinary skill in the art. Briefly, in certain aspects, the fluorinated species to be deposited onto the irradiated substrate may be vaporized, either by heating the fluorinated species to an appropriate temperature or reducing the pressure of the environment surrounding the fluorinated species. The irradiated substrate may be placed in the presence of the fluorinated species that either has been vaporized or is to be vaporized. The fluorinated species may then be deposited onto a surface of the irradiated substrate comprising a plurality of nanoscale and/or microscale features. In certain aspects, the irradiated substrate may be substantially cooler as compared to the elevated temperature of the fluorinated species that has been vaporized, thereby facilitating the deposition.

The temperature utilized during vapor deposition of the fluorinated species onto the surface of an irradiated substrate may be any of a variety of suitable temperatures and may be maintained within a deposition chamber for any appropriate amount of time depending on the deposition parameters for obtaining a uniform coating of the fluorinated species on the substrate. This may include temperatures below a boiling point of the fluorinated species. For example, the temperature utilized during vapor deposition of the fluorinated substrate onto the surface of the irradiated substrate may be greater than or equal to 100° C., greater than or equal to 110° C., greater than or equal to 120° C., greater than or equal to 130° C., greater than or equal to 140° C., greater than or equal to 150° C., greater than or equal to 160° C., greater than or equal to 170° C., greater than or equal to 180° C., or greater than or equal to 190° C. In certain embodiments, the temperature utilized during vapor deposition of the fluorinated species onto the surface of the irradiated substrate is less than or equal to 220° C., less than or equal to 200° C., less than or equal to 180° C., less than or equal to 170° C., less than or equal to 160° C., less than or equal to 150° C., less than or equal to 140° C., less than or equal to 130° C., less than or equal to 120° C., or less than or equal to 110° C. Combinations of the above recited ranges are also possible (e.g., the temperature utilized during vapor deposition of the fluorinated species onto the surface of the irradiated substrate is greater than or equal to 100° C. and less than or equal to 170° C., the temperature utilized during vapor deposition of the fluorinated substrate onto the surface of the irradiated substrate is greater than or equal to 100° C. and less than or equal to 220° C.). Other combinations are also possible.

Depending on the deposition parameters, the fluorinated species may be vapor deposited onto the irradiated substrate for any of a variety of suitable times to obtain a uniform coating on the substrate. For example, the fluorinated species may be vapor deposited onto the irradiated substrate for greater than or equal to 10 minutes, greater than or equal to 30 minutes, greater than or equal to 60 minutes, greater than or equal to 120 minutes, and the like. Correspondingly, the fluorinated species may be vapor deposited for times less than 180 minutes, 120 minutes, 60 minutes, and/or any other appropriate time period. Combinations of the above are contemplated, including for example deposition times between 10 minutes and 180 minutes. In some aspects, the time required to vapor deposit the fluorinated species onto the surface of the irradiated substrate is dependent on the temperature utilized for deposition.

As noted above, in certain embodiments, exposing an irradiated substrate to a fluorinated species includes immersing the irradiated substrate in a solution comprising the fluorinated species. Briefly, in some embodiments, an appropriate concentration of a fluorinated species (e.g., between 1 mM and 10 mM) may be added to a solvent (e.g. ethanol and/or any other appropriate solvent) in order to generate a stabilized solution of the fluorinated species. The solvent (e.g., ethanol) may comprise a base (e.g., sodium hydroxide). In other embodiments, an appropriate concentration of fluorinated species may be added to a dilute acid (e.g., diluted sulfuric acid). The irradiated substrate may then be immersed in the solution comprising the fluorinated species. The irradiated substrate may be immersed in a solution comprising the fluorinated species for any suitable time period to deposit the desired material onto a surface of the substrate. In some embodiments, for example, the irradiated substrate is immersed in the solution comprising the fluorinated species for greater than or equal to 30 minutes, greater than or equal to 60 minutes, greater than or equal to 90 minutes, greater than or equal to 120 minutes, greater than or equal to 150 minutes, greater than or equal to 180 minutes, and/or any other appropriate time period for obtaining a uniform coating of the fluorinated species on the substrate.

Other methods of exposing the fluorinated species to the irradiated substrate are also possible. In some embodiments, for example, a gas comprising a fluorinated species may be flowed across the irradiated substrate. In certain aspects, for example, the gas may be a mixture of N₂ and F₂. In certain other embodiments, a fluorinated species may be reacted with the irradiated substrate using a passivated fluorine reactor. In some such embodiments, the fluorinated species may be NiF₂.

In some embodiments, a mask may be applied after coating the substrate with the fluorinated species. In some such embodiments, the fluorinated species that is not masked may be removed (e.g., using UV ozone exposure), and the masked portion of the substrate may retain the fluorinated species. Such a masking technique may be advantageous to form a desired pattern of hydrophilic and/or superhydrophobic regions on a substrate.

In some embodiments, the method further comprises coating at least a portion of the surface of the irradiated substrate with the fluorinated species. For example, as shown in FIG. 1, method 100 comprises step 106 comprising coating at least a portion of the surface of the irradiated substrate with the fluorinated species once the substrate has been exposed to the fluorinated species. For example, one or more of the fluorinated species (e.g., a fluorinated silane) may coat at least a portion of the surface of the substrate, such as the microscale and/or nanoscale features disposed on a surface of the substrate, by chemically bonding to the surface, as explained herein in greater detail. In certain aspects, the fluorinated species may coat at least a portion of the substrate by chemically bonding to an oxide and/or hydroxide of the irradiated surface.

In some embodiments, the articles described herein may be used as a superhydrophobic materials for use in a number of different applications. In certain embodiments, for example, the articles described herein retain their superhydrophobic properties for extended periods of time (e.g., weeks, months, years) after producing the superhydrophobic materials using the methods described herein. In some embodiments, the superhydrophobic material may be used for any of a variety of applications, ranging from roofing material, siding material, fluid flow applications, and/or other appropriate to applications. In certain embodiments, for example, the article may be used in the development of anti-bacterial materials, anti-biofouling materials, anti-icing materials (e.g., in aircrafts and/or refrigerators), and/or antifogging materials (e.g., in windows and windshields). In some embodiments, the article may be used in drag-reducing materials (e.g., for under water applications or corrosion resistant materials). In some aspects, the article may be used for nuclear energy applications, such as fuel rod or cladding material in a nuclear reactor. Accordingly, in some aspects, the articles may be located within a nuclear reactor. In certain embodiments, at least a portion of the substrate may be superhydrophobic in order to promote or demote heat transfer abilities at certain applicable regions of the substrate. Such materials with finely-tuned heat transfer abilities may be used in nuclear reactors in order to facilitate heat suppression and/or removal during nuclear disasters.

The following example is intended to illustrate certain embodiments of the present disclosure, but do not exemplify the full scope of the disclosure.

### Example 1

The following example describes the production of various superhydrophobic materials and the evaluation of their hydrophobicity.

### Irradiating

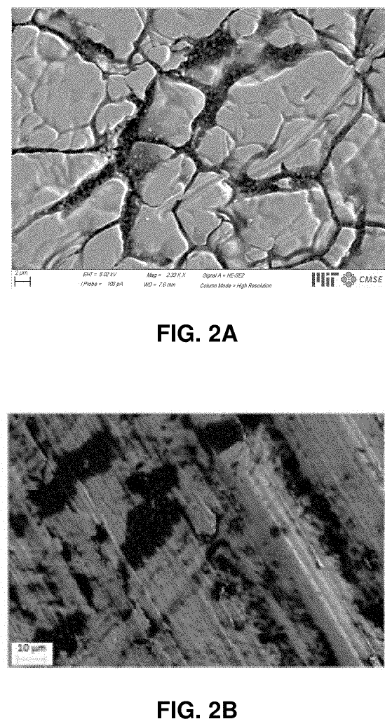

Separate samples of zircaloy-4, copper 110, stainless steel 316, and silicon carbide were obtained. The samples were irradiated with gamma irradiation utilizing a Cobalt-60 source. The samples were kept in an aluminum basket (or another clean surface) and irradiated in the gamma cell. The net accumulated dose of each sample was at least 120 kGy and less than or equal to 20,000 kGy to avoid complete surface oxidation. Non-limiting examples of metallic surfaces that have been exposed to gamma irradiation are shown in FIG. 2A and FIG. 2B. FIG. 2A is a SEM image of a surface exposed to gamma irradiation with scale bar equal to 2 micrometers. FIG. 2B is a SEM image of a surface exposed to gamma irradiation with scale bar equal to 10 micrometers. The substrates in FIG. 2A and FIG. 2B were stainless steel grade 316 and Zircaloy-4, respectively.

The oxides and/or hydroxides formed on the surface due to gamma irradiation are susceptible to environmental organics, so the irradiated samples were wrapped with a metal foil or kept in a vacuum before fluorination.

### Fluorinating

In order to fluorinate the samples, a small open vial containing a 0.5 mL sample of an alkyl fluoro-silane (e.g., 1H,1H,2H,2H-perfluorodecyltriethoxysilane) was placed in a polytetrafluoroethylene (PTFE) container. The PTFE container was tightly sealed, placed in an oven, and preheated uniformly (e.g., at 140° C.) for 30 minutes. Preheating was done to allow the vapor inside the PTFE container to reach a uniform temperature. The samples were then placed in the PTFE container proximate to the vial, and the PTFE container was heated again. The samples were removed and allowed to dry for at least 12 hours before measuring the contact angle.

The temperature range during chemical vapor deposition of the fluorinated species was typically greater than 110° C. to allow for vaporization of the chemical, and below the boiling point of the chemical(s) (e.g., 220° C.). The time of chemical vapor deposition was optimized based on the temperature utilized to obtain the uniform coating.

### Measuring Water Contact Angle

Prior to measuring the water contact angle, the samples were pre-cleaned by sonicating in and rinsing with high-grade acetone, then rinsing with high-grade denatured ethanol, and rinsing with deionized water. Following the sonicating and rinsing procedure, the samples were blow dried with nitrogen and/or helium.

The water contact angle for all samples was measured at room temperature (e.g., 23+/−2° C.) and at relative humidity (e.g., >50%). The contact angle goniometer was set up so that the measuring stage was level, and the test samples were placed on the instrument with the necessary fixtures, making sure that the measuring stage and samples were horizontal. The tip of the needle was attached to a syringe filled with water at a distance of 3 mm to 5 mm from the surface of the samples to be tested, and a drop of water with an approximate volume of 5 microliters was deposited on the surface of the samples. The goniometer eyepiece and the internal measuring mechanism were adjusted so that the interior angle of each of the two points of contact of the drop could be determined. Two angle measurements were made within thirty seconds of depositing the drop (e.g., one on each edge of the drop), and three drops were evaluated for each sample.

The water contact angle of various samples fabricated by gamma irradiation and fluorination is shown in Table 1, as compared to both gamma irradiated only samples and fluorinated only samples.

TABLE 1

| | Water Contact Angle (°) | | | | | |
|---|---|---|---|---|---|---|
| | | | | | Present Method | |
| | Gamma | | | | (Gamma | |
| | Irradiated | | Fluorinated | | Irradiation and | |
| | | Std. | | Std. | Fluorination) | |
| Substrate | Average | dev. | Average | dev. | Average | Std. dev. |
| Zircaloy-4 | 85.64 | 4.8 | 95.45 | 3.5 | 164.72 | 4.5 |
| Copper 110 | 86.78 | 5.4 | 101.12 | 4.8 | 168.4 | 3.8 |
| Stainless Steel 316 | 79.25 | 3.8 | 93.12 | 6.2 | 153.4 | 7.8 |
| Silicon Carbide | 69.45 | 6.5 | N/A | N/A | 127.4 | 4.3 |

### Example 2

The following example compares the water contact angle of various samples fabricated by various doses of gamma irradiation and fluorination, as compared to both the samples as machined and fluorinated only samples.

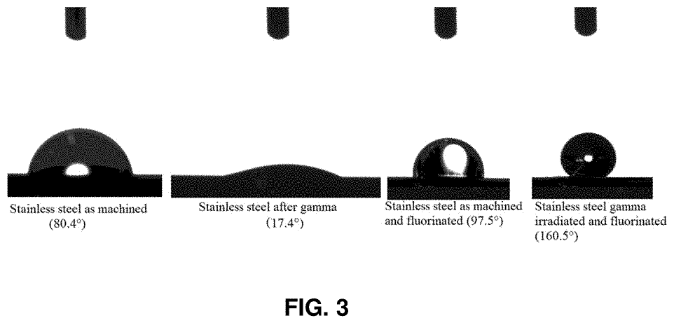

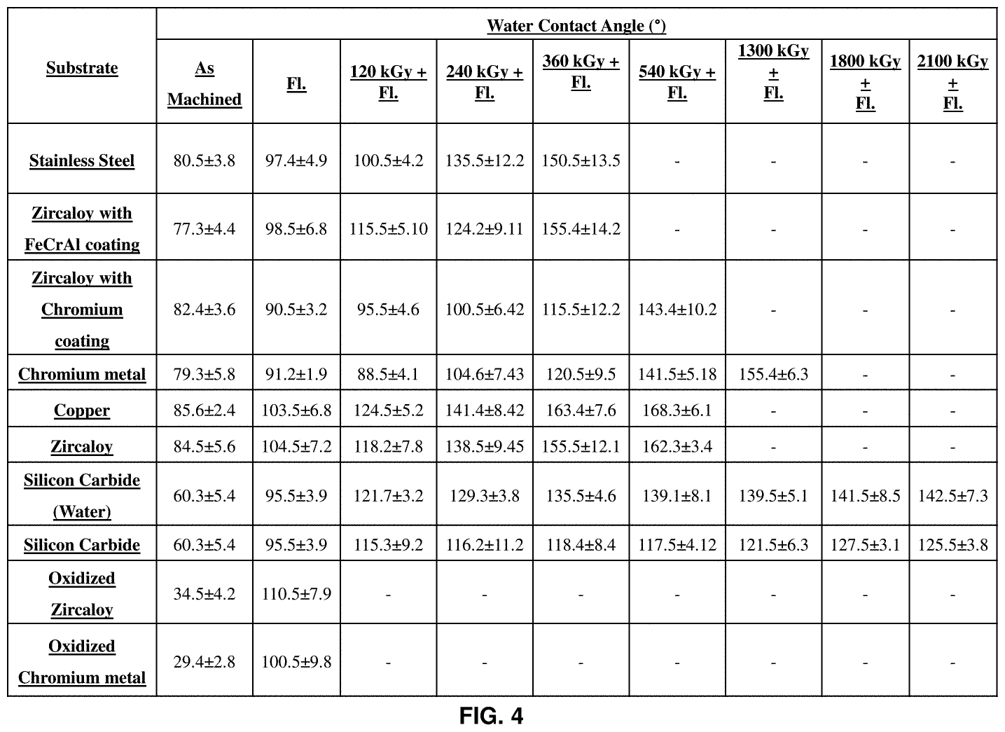

Several samples were obtained, irradiated, and fluorinated as explained above with respect to Example 1. The water contact angle of each sample was also measured, as explained above with respect to Example 1. Images of the water contact angle on stainless steel are shown in FIG. 3 for various conditions. The measured water contact angle of various samples fabricated by various doses of gamma irradiation and fluorination is included in the table shown in FIG. 4. The water contact angles are compared to as machined samples and samples that have only been fluorinated without radiation. Oxidized zircaloy and chromium metal samples there were in the as machined state and that had been fluorinated without radiation were included to illustrate the difference to similar samples. In short, increasing hydrophobicity was generally seen with increasing gamma radiation dosage and the samples that were exposed to radiation and fluorination exhibited greater hydrophobicity than the corresponding oxidized samples exposed to fluorination.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. An article, comprising:
a substrate;
a plurality of nanoscale and/or microscale features on a surface of the substrate, wherein the plurality of nanoscale and/or microscale features comprise oxides and/or hydroxides on the surface of the substrate; and
a fluorinated coating associated with at least a portion of the surface of the substrate.

2. The article of claim 1, wherein the at least a portion of the surface has a water contact angle of greater than or equal to 150°.

3. The article of claim 1, wherein the substrate comprises a material with an average crystal size between or equal to 100 nm and 100 micrometers.

4. The article of claim 1, wherein the substrate comprises a metal and/or a metal alloy.

5. The article of claim 1, wherein the substrate comprises a ceramic.

6. The article of claim 1, wherein the fluorinated coating comprises a fluorinated silane.

7. The article of claim 1, wherein the fluorinated coating is attached to at least a portion of the surface of the substrate by chemical bonding.

8. The article of claim 1, wherein the plurality of nanoscale and/or microscale features are patterned on the substrate.

9. The article of claim 1, wherein the fluorinated coating is disposed on the plurality of nanoscale and/or microscale features.

10. A method of producing a superhydrophobic material, comprising:
irradiating a surface of a substrate with gamma irradiation;
exposing the irradiated substrate to a fluorinated species; and
coating at least a portion of the surface of the irradiated substrate with the fluorinated species.

11. The method of claim 10, wherein irradiating the surface of the substrate includes irradiating the surface of the substrate with at least 120 kiloGray of gamma irradiation.

12. The method of claim 10, further comprising exposing the substrate to oxygen during irradiation.

13. The method of claim 10, wherein exposing the irradiated substrate to the fluorinated species includes vapor depositing the fluorinated species onto the irradiated substrate.

14. The method of claim 10, wherein exposing the irradiated substrate to the fluorinated species includes immersing the irradiated substrate in a solution comprising the fluorinated species.

15. The method of claim 10, wherein the at least a portion of the surface has a water contact angle of greater than or equal to 150°.

16. The method of claim 10, wherein the substrate comprises a metal or metal alloy.

17. The method of claim 10, wherein the substrate comprises a ceramic.

18. The method of claim 10, wherein the fluorinated coating is disposed on a plurality of nanoscale and/or microscale features on the surface of the substrate.

19. The method of claim 10, wherein the substrate comprises a material with an average crystal size between or equal to 100 nm and 100 micrometers.
